(19) United States
(12) Patent Application Publication
(10) Pub. No.: US 2010/0258422 A1
(43) Pub. Date: Oct. 14, 2010

(54) KEYSWITCH AND KEYBOARD

(76) Inventor: Yi-Chen WANG, Yongkang City (TW)

Correspondence Address: NORTH AMERICA INTELLECTUAL PROPERTY CORPORATION, P.O. BOX 506, MERRIFIELD, VA, 22116, US

(21) Appl. No.: 12/757,879

(22) Filed: Apr. 9, 2010

(30) Foreign Application Priority Data
Apr. 13, 2009 (TW) 098206037

(51) Int. Cl. H01H 13/7065

(52) U.S. Cl. 200/344

(57) ABSTRACT

A keyswitch and a keyboard are provided. The keyboard includes the keyswitch, and the keyswitch includes a base, a position limiting component, a balance beam, and a keycap. The position limiting component is disposed on the base and has a clipping portion and a position limiting portion. The balance beam has an engaging portion which is adapted to be engaged with the position limiting portion. The keycap has a pivotal structure for pivotally connecting the balance beam. When the balance beam is assembled toward the position limiting component, the engaging portion pushes the clipping portion to leave an initial position and then be engaged to the position limiting portion, and when the clipping portion recovers to the initial position, the engaging portion is limited at the position limiting portion by the clipping portion.

### BACKGROUND OF THE INVENTION

1. Field of the invention

The invention relates to a keyswitch, and more particularly, to a keyswitch structure having a balance beam capable of being vertically assembled to the base.

2. Description of the prior art

With the growth of information technology, the information equipment will be also become popular gradually. Taking the most-used computer for example, there are various brands and types of computers on the market, and the application range of the computer even extends to the places such as family, factory, company, office, and school. The use level of the computer reaches all levels and almost becomes everyday essential items in daily life. In the well-known computer, such as desktop computer and notebook, a keyboard is needed for the user to input a character or other input operations.

As to the keyboard used in current desktop computer, the keyboard has a key cap and a base, and a key column is disposed between the key cap and the base. When the user presses a keyswitch on the keyboard, the key column will support the key cap to move vertically relative to the base. In this way, when the key cap is pressed, the switch on the base can be triggered to transfer a reference signal to the processor to trigger the processor to output a suitable output signal. The shape of the conventional keyswitch (e.g., the functional keyswitch of A, F1, or ESC) of the keyboard is mostly square, and the structures and operation methods of these keyswitches are mentioned above.

In addition, there are also some special multiple keyswitches (e.g., SPACE, SHIFT, and ENTER) on the keyboard having longer length or special shape. These keyswitches may have special appearance based on the using frequency or keyboard configuration.

For example, when the user types characters, the keyswitch “SPACE” is usually used. In order to let the user press the keyswitch “SPACE” easily, the keyswitch “SPACE” on the keyboard is often designed to have a longer appearance, so that the user can use his/her thumb to press the keyswitch “SPACE”.

However, since the keyswitch “SPACE” is longer, the user may press the two sides of the keyswitch “SPACE” instead of the central position of the keyswitch “SPACE”. As a result, the keyswitch “SPACE” will become tilted and unstable, or fail to trigger the switch corresponding to the keyswitch “SPACE”, even the keyswitch “SPACE” will be damaged. Therefore, a balance beam is usually disposed on the current multiple switches to be pivoted on the bottom of the key cap and the base. The balance beam can prevent the multiple keyswitches from being tilted and unstable, and the pressing force of the user can be uniformly distributed to everywhere on the keyswitch. Even the user presses on a corner of the keyswitch, and the corner is far away from the triggering switch, the pressing force of the user can be uniformly distributed to the entire keyswitch, so that the keyswitch will become more sensitive and comfortable for the user.

However, conventionally, the balance beam must be completely assembled by manpower; the balance beam may fail to be assembled on the correct position due to the worker's carelessness. Moreover, the efficiency will become poor because the workers are overworked, and the manpower cost will become higher, and these drawbacks will be negative to the enterprise earnings.

Therefore, the invention provides a keyswitch and a keyboard, the assembling method of its balance beam is to use a vertical assembling method. In this way, the balance beam can be assembled by machine. Therefore, not only the manpower cost will be saved and the human error will be prevented, but also the productivity can be enhanced to increase the enterprise earnings.

### SUMMARY OF THE INVENTION

The invention discloses a keyswitch including a base, a position limiting component, a balance beam, and a key cap. The position limiting component is disposed on the base and has a clipping portion and a position limiting portion. The balance beam has an engaging portion adapted to be engaged in the position limiting portion. The key cap has a pivotal structure for pivotally connecting with the balance beam.

The clipping portion includes a first clipper and a second clipper. An opening is formed between the first clipper and the second clipper, and the size of the opening is smaller than the size of the clipping portion. In addition, the position limiting portion has a height larger than the size of the clipping portion. When the balance beam and the key cap are linked, the clipping portion will move upward and downward in the position limiting portion.

The key cap has a pivotal structure for pivotally connecting with the balance beam. When the balance beam is assembled toward the position limiting component, the engaging portion pushes the clipping portion to leave an initial position and then be engaged to the position limiting portion, and when the clipping portion recovers to the initial position, the engaging portion is limited at the position limiting portion by the clipping portion.

Furthermore, the keyswitch of the invention further includes a crevice formed on the base and near the position limiting component. When the clipping portion moves upward and downward in the position limiting portion, a part of the clipping portion will pass through the crevice.

The invention also discloses a keyboard including a base and a plurality of keyswitches. The plurality of keyswitches is disposed on the base, wherein each of plurality of keyswitches includes a position limiting component, a balance beam, and a key cap. The balance beam has an engaging portion adapted to be engaged with the position limiting portion. The key cap has a pivotal structure for pivotally connecting with the balance beam. When the balance beam is assembled toward the position limiting component, the engaging portion pushes the clipping portion to leave an initial position and then be engaged to the position limiting portion, and when the clipping portion recovers to the initial position, the engaging portion is limited at the position limiting portion by the clipping portion.

Compared to the prior art, in the keyswitch and the keyboard of the invention, the assembling method of the balance beam is to use the vertical assembling method to make the balance beam to be engaged and limited in the position limiting component. In this way, an entire row or face of balance beams can be assembled at the same time by the equipment instead of being assembled one after one by hands. By doing so, not only the manpower cost will be saved and the human error will be prevented, but also the productivity can be enhanced to increase the enterprise earnings.

The objective of the present invention will no doubt become obvious to those of ordinary skill in the art after reading the following detailed description of the preferred embodiment, which is illustrated in the various figures and drawings.

BRIEF DESCRIPTION OF THE APPENDED DRAWINGS

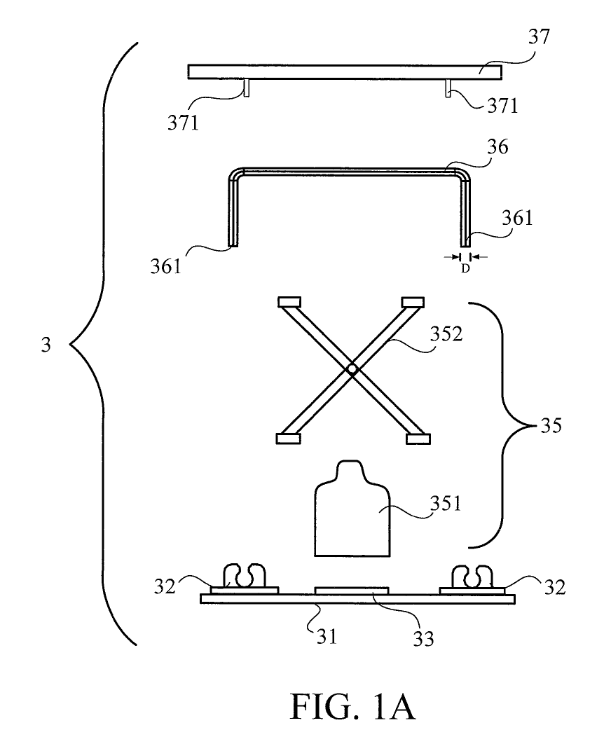

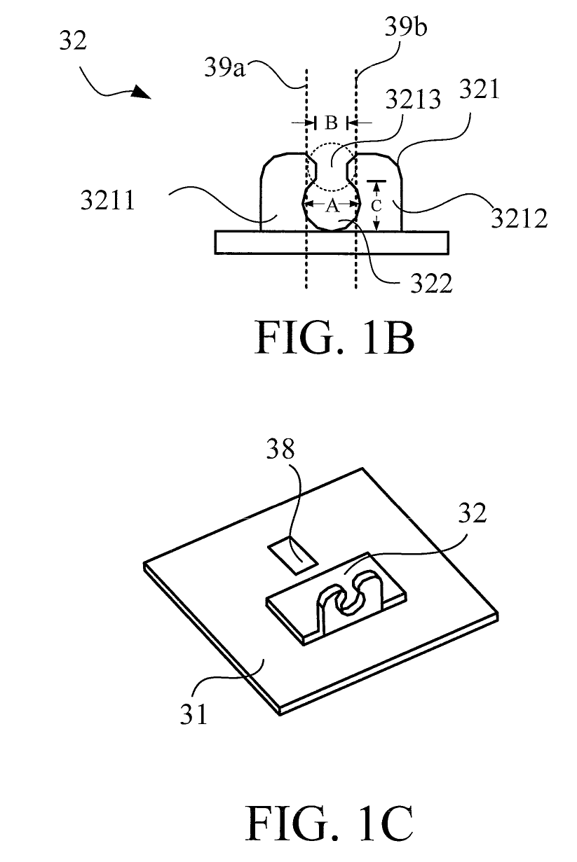

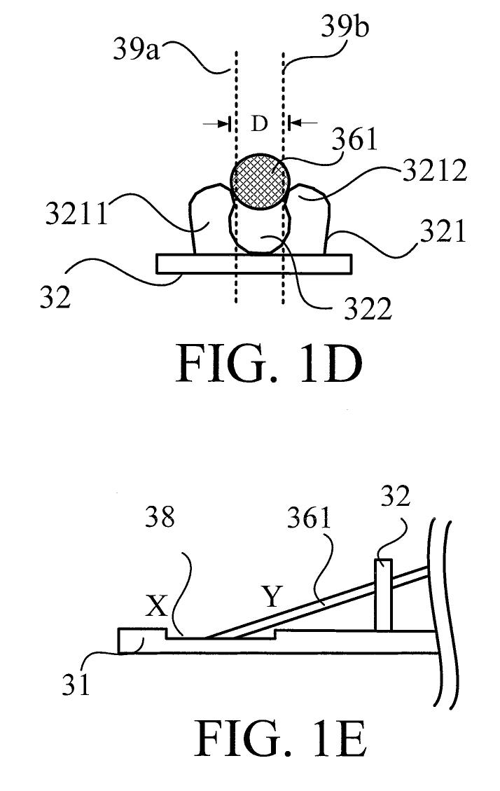

FIG. 1A shows an exploded diagram of a keyswitch of an embodiment in the invention.

FIG. 1B shows an enlarged scheme diagram of the position limiting component shown in FIG. 1A.

FIG. 1C shows a scheme diagram of the position limiting component shown in FIG. 1A.

FIG. 1D shows a scheme diagram of the balance beam and the position limiting component.

FIG. 1E shows a side view of the balance beam disposed on the position limiting component.

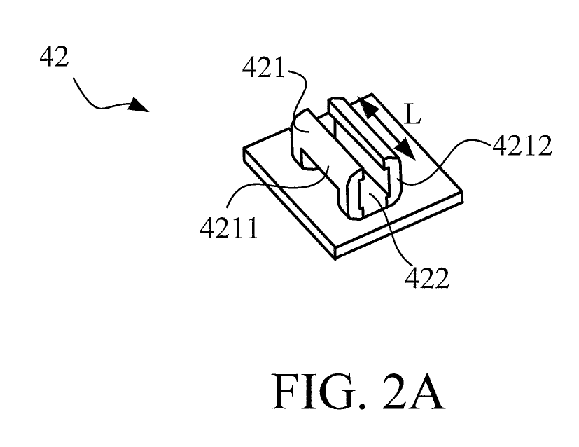

FIG. 2A shows a scheme diagram of another embodiment of the position limiting component.

### DETAILED DESCRIPTION OF THE INVENTION

Please refer to FIG. 1A. FIG. 1A shows an exploded diagram of a keyswitch 3 of an embodiment in the invention. As shown in FIG. 1A, the keyswitch 3 of the invention includes a base 31, a position limiting component 32, a thin-film circuit board 33, a supporting module 35, a balance beam 36, and a key cap 37.

Please also refer to FIG. 1B and FIG. 1C. FIG. 1B shows an enlarged scheme diagram of the position limiting component 32 shown in FIG. 1A. FIG. 1C shows a scheme diagram of the position limiting component 32 shown in FIG. 1A. As shown in FIG. 1A, FIG. 1B, and FIG. 1C, the position limiting component 32 is disposed on the base 31. The position limiting component 32 has a clipping portion 321 and a position limiting portion 322. Especially, the base and the position limiting component 32 can be one-batch formed, but not limited to this case. In addition, the position limiting component 32 can be made of a plastic material or an elastic material, but also not limited to this case.

The thin-film circuit board 33 is disposed between an elastic object 351 and the base 31 and used for generating a pressing signal. When the pressing signal is generated, it means that the keyswitch 3 was already pressed.

The supporting module 35 includes an elastic object 351 and a supporting component 352. And, the elastic object 351 and the supporting component 352 are both disposed between the base 31 and the key cap 37 and used for supporting the key cap 37 to move vertically relative to the base 31. Especially, the appearance and type of the supporting component 352 are not limited by the figure of this embodiment.

The balance beam 36 has a engaging portion 361 adapted to be engaged in the position limiting portion 322. And, the engaging portion 361 of the balance beam 36 has a size of width D.

The key cap 37 has a pivotal structure 371 for pivotally connecting with the balance beam 36. When the key cap 37 moves vertically relative to the base 31, the key cap 37 will pivot to the balance beam 36 via the pivotal structure 371 to further bring the balance beam 36 to move vertically.

In this embodiment, the clipping portion 321 of the position limiting component 32 includes a first clipper 3211 and a second clipper 3212. Wherein, the first clipper 3211 and the second clipper 3212 can be stably located at an initial position 39a and an initial position 39b respectively without any influence of external force. Especially, the shape and size of the first clipper 3211 and the second clipper 3212 can be defined by the designer, not limited to this case.

In addition, an opening 3213 is formed between the first clipper 3211 and the second clipper 3212. And, the position limiting portion 322 has a size of width A, and the opening 3213 has a size of width B. Wherein, the width B of the opening 3213 is smaller than the width A of the position limiting portion 322. And, the width B of the opening 3213 is smaller than the width D of the engaging portion 361 of the balance beam 36. In addition, the position limiting portion 322 has a height C larger than the width D of the engaging portion 361. When the balance beam 36 and the key cap 37 are linked, the engaging portion 361 of the balance beam 36 will move upward and downward in the position limiting portion 322.

In this embodiment, the keyswitch 3 of the invention further includes a crevice 38 formed on the base 31 and near the position limiting component 32. When the engaging portion 361 moves upward and downward in the position limiting portion 322, a part of the engaging portion 361 will pass through the crevice 38.

Since the components and their connection relationships of the keyswitch 3 in this invention is already described in detail above, therefore, the following will describe more detail about the practical operation methods between the balance beam 36 and the position limiting component 32 of the keyswitch 3 in this invention.

Please refer to FIG. 1A, FIG. 1B, FIG. 1C, and FIG. 1D. FIG. 1D shows the scheme diagram of the balance beam 36 and the position limiting component 32. As shown in FIG. 1A, FIG. 1B, FIG. 1C, and FIG. 1D, when the engaging portion 361 of the balance beam 36 is vertically assembled toward the position limiting component 32 relative to the base 31, the engaging portion 361 of the balance beam 36 will push the first clipper 3211 and the second clipper 3212 of the clipping portion 321 away from their initial positions 39a and 39b respectively.

In other words, since the width D of the engaging portion 361 of the balance beam 36 is larger than the width B of the opening 3213 formed between the first clipper 3211 and the second clipper 3212 of the clipping portion 321, and the first clipper 3211 and the second clipper 3212 of the clipping portion 321 are elastic, so that the opening 3213 formed between the first clipper 3211 and the second clipper 3212 of the clipping portion 321 will be further pushed by the engaging portion 361 of the balance beam 36 to be distracted to the right and the left.

In this embodiment, after the opening 3213 formed between the first clipper 3211 and the second clipper 3212 of the clipping portion 321 is pushed by the engaging portion 361 of the balance beam 36 to be distracted to the right and the left, the engaging portion 361 of the balance beam 36 can pass through the opening 3213 to be engaged into the position limiting portion 322.

Additionally, since the first clipper 3211 and the second clipper 3212 of the clipping portion 321 are elastic, therefore, after the engaging portion 361 of the balance beam 36 passes through the opening 3213 to be engaged into the position limiting portion 322, the first clipper 3211 and the second clipper 3212 of the clipping portion 321 will be recovered to the initial positions 39a and 39b respectively. After the first clipper 3211 and the second clipper 3212 of the clipping portion 321 are recovered to the initial positions 39a and 39b respectively, the engaging portion 361 of the balance beam 36 will be limited in the position limiting portion 322 by the first clipper 3211 and the second clipper 3212 of the clipping portion 321.

Please also refer to FIG. 1E. FIG. 1E shows a side view of the balance beam 36 disposed on the position limiting component 32. As shown in FIG. 1E, the balance beam 36 is limited on the position limiting portion 322 of the position limiting component 32. After the key cap 37 is pivoted to the balance beam 36 (not shown in FIG. 1E) and the key cap 37 brings the pivoted balance beam 36 to move upward and downward relative to the base 31, the tail end of the balance beam 36 will move leftward and rightward on the crevice 38 from X to Y direction or from Y to X direction.

Please also refer to FIG. 2A. FIG. 2A shows a scheme diagram of another embodiment of the position limiting component. In this embodiment, the only difference between the position limiting component 32 and the position limiting component 42 is their shapes are different, but the theorem and method of assembling their balance beams are the same with those mentioned above, so it will be not mentioned again here. Therefore, only important components shown in FIG. 2A are labeled, and only the difference between the position limiting component 32 and the position limiting component 42 will be discussed as follows.

As shown in FIG. 2A, the position limiting component 42 has the clipping portion 421 and the position limiting portion 322. And, the clipping portion 421 includes the first clipper 4211 and the second clipper 4212. Then, after comparing FIG. 2A with FIG. 1C, it can be found that the thickness L of the first clipper 4211 and the second clipper 4212 of the position limiting component 42 is larger than that of the position limiting component 32.

Therefore, when the engaging portion 361 of the balance beam 36 is engaged on the position limiting portion 422 of the position limiting component 42, the strength of limiting the engaging portion 361 of the balance beam 36 will be stronger than the position limiting portion 322 of the position limiting component 32. In other words, since the position limiting component 42 engages more area of the engaging portion 361 of the balance beam 36 than the position limiting component 32 does; therefore, its strength of limiting the engaging portion 361 of the balance beam 36 will be relatively stronger.

In an embodiment, the invention also provides a keyboard, the keyboard includes a plurality of keyswitches, and at least one of the keyswitches has the above-mentioned structure. Since the characteristic of the keyboard and the effects it can achieve are the same with those mentioned above, so it will not mentioned again here.

Compared to the prior art, in the keyswitch and the keyboard of the invention, the assembling method of the balance beam is to use the vertical assembling method to make the balance beam to be engaged and limited in the position limiting component. In this way, an entire row or face of balance beams can be assembled at the same time by the equipment instead of being assembled one after one by hands. By doing so, not only the manpower cost will be saved and the human error will be prevented, but also the productivity can be enhanced to increase the enterprise earnings.

Although the present invention has been illustrated and described with reference to the preferred embodiment thereof, it should be understood that it is in no way limited to the details of such embodiment but is capable of numerous modifications within the scope of the appended claims.

What is claimed is:

1. A keyswitch, comprising:
a base;
a position limiting component, disposed on the base, the position limiting component having a clipping portion and a position limiting portion;
a balance beam having an engaging portion adapted to be engaged with the position limiting portion; and
a key cap having a pivotal structure for pivotally connecting with the balance beam;
wherein when the balance beam is assembled toward the position limiting component, the engaging portion pushes the clipping portion to leave an initial position and then be engaged to the position limiting portion, and when the clipping portion recovers to the initial position, the engaging portion is limited at the position limiting portion by the clipping portion.

2. The keyswitch of claim 1, wherein the clipping portion comprises a first clipper and a second clipper, an opening is formed between the first clipper and the second clipper, and the size of the opening is smaller than the size of the clipping portion.

3. The keyswitch of claim 1, wherein the position limiting portion has a height larger than the size of the clipping portion, when the balance beam and the key cap are linked, the clipping portion moves upward and downward in the position limiting portion.

4. The keyswitch of claim 3, further comprising a crevice formed on the base and near the position limiting component, when the clipping portion moves upward and downward in the position limiting portion, a part of the clipping portion passing through the crevice.

5. The keyswitch of claim 1, wherein the base and the position limiting component are one-batch formed.

6. The keyswitch of claim 1, further comprising a supporting module, the supporting module comprising an elastic object and a supporting component, the supporting module being disposed between the base and the key cap and used for supporting the key cap to move vertically relative to the base.

7. The keyswitch of claim 6, further comprising a thin-film circuit board disposed between the elastic object and the base, the thin-film circuit board being used for generating a pressing signal.

8. The keyswitch of claim 1, wherein the position limiting component is made of a plastic material.

9. The keyswitch of claim 1, wherein the position limiting component is made of an elastic material.

10. A keyboard, comprising:
a base; and
a plurality of keyswitches disposed on the base, each of the plurality of keyswitches comprising:
a position limiting component, disposed on the base, the position limiting component having a clipping portion and a position limiting portion;
a balance beam having an engaging portion adapted to be engaged with the position limiting portion; and
a key cap having a pivotal structure for pivotally connecting with the balance beam;
wherein when the balance beam is assembled toward the position limiting component, the engaging portion pushes the clipping portion to leave an initial position and then be engaged to the position limiting portion, and when the clipping portion recovers to the initial position, the engaging portion is limited at the position limiting portion by the clipping portion.

11. The keyboard of claim 10, wherein the clipping portion comprises a first clipper and a second clipper, an opening is formed between the first clipper and the second clipper, and the size of the opening is smaller than the size of the clipping portion.

12. The keyboard of claim 10, wherein the position limiting portion has a height larger than the size of the clipping portion, when the balance beam and the key cap are linked, the clipping portion moves upward and downward in the position limiting portion.

13. The keyboard of claim 12, further comprising a crevice formed on the base and near the position limiting component, when the clipping portion moves upward and downward in the position limiting portion, a part of the clipping portion passing through the crevice.

14. The keyboard of claim 10, wherein the base and the position limiting component are one-batch formed.

15. The keyboard of claim 10, further comprising a supporting module, the supporting module comprising an elastic object and a supporting component, the supporting module being disposed between the base and the key cap and used for supporting the key cap to move vertically relative to the base.

16. The keyboard of claim 10, further comprising a thin-film circuit board disposed between the elastic object and the base, the thin-film circuit board being used for generating a pressing signal.

17. The keyboard of claim 10, wherein the position limiting component is made of a plastic material.

18. The keyboard of claim 10, wherein the position limiting component is made of an elastic material.
